(19) United States
(12) Patent Application Publication
(10) Pub. No.: US 2018/0111422 A1
(43) Pub. Date: Apr. 26, 2018

(54) TIRE

(71) Applicant: BRIDGESTONE CORPORATION, Tokyo (JP)

(72) Inventors: Tatsuya TOMIDA, Kodaira-shi, Tokyo (JP); Hideyuki SAKURAI, Ogawacho-Kodairashi, Tokyo (JP)

(73) Assignee: BRIDGESTONE CORPORATION, Tokyo (JP)

(21) Appl. No.: 15/558,680

(22) PCT Filed: Mar. 30, 2016
(86) PCT No.: PCT/JP2016/001858

§ 371 Date: Sep. 15, 2017

(30) Foreign Application Priority Data
Apr. 1, 2015 (JP) 2015-075323

(51) Int. Cl. B60C 11/03; B60C 1/00; B60C 11/00; B60C 11/12; C08K 3/04; C08K 5/02; C08K 11/00; C08K 3/22; C08K 5/03; C08L 9/00; C08L 9/06

(52) U.S. Cl. CPC B60C 11/033; B60C 1/0016; B60C 11/0008; B60C 11/1236; C08K 3/04; C08K 5/02; C08K 2201/006; C08K 3/22; C08K 5/03; C08L 9/00; C08L 9/06; B60C 2011/0025; C08K 2003/2296; C08K 11/00

(57) ABSTRACT

This disclosure aims to provide a tire having excellent braking performance on dry road surface and on wet road surface, and having excellent steering stability. This disclosure is a tire comprising a tread 10 formed by using a rubber composition of which a tan δ at 0° C. is 0.25 to 0.55, a difference between a tan δ at 30° C. and a tan δ at 60° C. is −0.02 to 0.07, and a dynamic storage modulus at a dynamic strain of 1% and 0° C. is 4 MPa to 20 MPa, wherein: the tread 10 has circumferential grooves 20 extending in a tire circumferential direction C; a negative ratio in a footprint is 15% to 25%; a negative ratio derived from the circumferential grooves 20 is 8% to 14%; and a negative ratio derived from grooves other than the circumferential grooves is 7% to 11%.

### TECHNICAL FIELD

This disclosure relates to a tire.

### BACKGROUND

In view of improving vehicle safety, it is desired to improve tire's braking performance and driving performance not only on a dry road surface but on various road surfaces such as a wet road surface and an icy and snowy road surface.

For example, PTL1 (JPH09-67469A) discloses a tire using a tread rubber with increased 0° C. tan δ for the purpose of improving the gripping performance on wet road surface.

On the other hand, in the case where a tire is used throughout a year, since the road surface temperature varies depending on change of the seasons, etc., there are cases that the fuel efficiency varies when the tire runs in ordinary temperature environment and when the tire runs in low temperature environment. It has been discovered that such variation of fuel efficiency increases as the 0° C. tan δ increases. Then, we discovered that by using a rubber composition having specific physical properties (specifically, a tan δ at 0° C. being 0.25 to 0.55, a difference between a tan δ at 30° C. and a tan δ at 60° C. being −0.02 to 0.07, and a dynamic storage modulus at a dynamic strain of 1% and 0° C. being 4 MPa to 20 MPa) to a tread, it is possible to reduce the difference between the fuel efficiency in low temperature environment and the fuel efficiency in ordinary temperature environment, and to sufficiently ensure the wet performance.

### CITATION LIST

### Patent Literature

PTL 1: JPH09-67469A

### SUMMARY

### Technical Problem

However, in a tire using a tread rubber having the aforementioned physical properties, further improvement of the braking performance on dry road surface is desired, and better wet braking performance is requested on a road surface which is more slippery as compared to asphalt, such as manhole and the like.

Therefore, it was desired to improve the braking performance on dry road surface and on wet road surface by further studying the formulation of the rubber composition. However, even in the case where it was possible to improve the braking performance on dry road surface and on wet road surface by studying the formulation of the rubber composition, deterioration of the steering stability was predicted. Since optimization of the formulation of the rubber composition is for the purpose of improving the braking performance by adjusting the loss property at low temperature and at high temperature, the rigidity of the tread was not considered, and there was a risk of deterioration of the steering stability due to deterioration of the tread rigidity.

Then, this disclosure aims to provide a tire having excellent braking performance on dry road surface and on wet road surface, and having excellent steering stability.

### Solution to Problem

In order to achieve the aforementioned purpose, we have intensively studied a tire including a tread formed by using a rubber composition having specific physical properties.

Further, we discovered that regarding the tread, by setting a negative ratio in a footprint within a specific range, and setting a negative ratio derived from a circumferential groove and a negative ratio derived from grooves other than the circumferential groove within a specific range as well, it is possible to improve the land portion rigidity of the tread, and thus it is possible to achieve both excellent braking performance on dry road surface and on wet road surface and excellent steering stability. Thereby, we have accomplished this disclosure.

The tire of this disclosure is a tire comprising a tread formed by using a rubber composition of which a tan δ at 0° C. is 0.25 to 0.55, a difference between a tan δ at 30° C. and a tan δ at 60° C. is −0.02 to 0.07, and a dynamic storage modulus at a dynamic strain of 1% and 0° C. is 4 MPa to 20 MPa, wherein: the tread has a circumferential groove extending continuously in a tire circumferential direction; a negative ratio in a footprint is 15% to 25%; a negative ratio derived from the circumferential groove is 8% to 14%; and a negative ratio derived from grooves other than the circumferential groove is 7% to 11%.

According to the aforementioned configuration, it is possible to achieve both excellent braking performance on dry road surface and on wet road surface and excellent steering stability.

In the tire of this disclosure, it is preferable that the tread has a central region partitioned by two circumferential grooves located on tire widthwise outermost sides among the circumferential grooves, and two side regions on tire widthwise outer sides of the central region; and a negative ratio of the two side regions in a footprint is larger than a negative ratio of the central region in a footprint. It is more preferable that a ratio of an area of a central land portion located within the central region to an area of an entire tire land portion on the footprint of the tread is 40% to 60, an independent land portion width of the central land portion being 1.5 times or more of a groove depth of the circumferential groove adjacent on a tire widthwise outer side of the central land portion.

This is because that it is possible to achieve more excellent steering stability.

In the tire of this disclosure, it is preferable that the central land portion has a plurality of widthwise narrow grooves which open to one of the circumferential grooves and do not connect to another adjacent circumferential groove. Further, it is more preferable that the widthwise narrow grooves extend in a direction at 50° to 85° with respect to the tire circumferential direction, and that the widthwise narrow grooves are arranged alternately in the tire circumferential direction with widthwise narrow grooves extending oppositely across a tire equator, an arranging interval in the tire circumferential direction of widthwise narrow grooves opening to the same circumferential groove being 0.5% to 4.5% of a circumferential length of a tire equatorial plane on a tread surface, or that the widthwise narrow grooves are comprised of sipes and/or notch grooves.

This is because that it is possible to ensure the land portion rigidity of the tread, and to simultaneously further improve the braking performance when wet.

In the tire of this disclosure, it is preferable that side land portions located within the side regions have lug grooves, each of the lug grooves not connecting to an adjacent one of the circumferential grooves, or connecting to the adjacent one of the circumferential grooves in a state where a part of a groove bottom is raised up.

This is because that it is possible to achieve more excellent steering stability.

In the tire of this disclosure, it is preferable that the tread is formed with a rubber composition containing: a rubber component A containing 50 mass % or more of a diene based rubber; and 5 to 50 parts by mass per 100 parts by mass of the rubber component of at least one additive component B selected from a thermoplastic resin, an oil or a low molecular weight aromatic vinyl compound-conjugated diene compound copolymer with a polystyrene-equivalent weight-average molecular weight of 5,000 to 200,000 measured by gel permeation chromatography.

This is because that it is possible to improve the braking performance on dry road surface and on wet road surface more securely.

Moreover, in the tire of this disclosure, it is preferable that the diene based rubber is a natural rubber or a butadiene rubber.

This is because that it is possible to improve the braking performance on dry road surface and on wet road surface more securely.

In the tire of this disclosure, it is preferable that the thermoplastic resin is a C5 based resin, a C9 based resin, a C5 to C9 based resin, a dicyclopentadiene based resin, a rosin based resin, an alkylphenol based resin, or a terpenephenol based resin.

This is because that it is possible to improve the braking performance on dry road surface and on wet road surface more securely.

In the tire of this disclosure, it is more preferable that the additive component B contains a Novolak-type phenol resin.

This is because that it is possible to achieve more excellent steering stability.

In the tire of this disclosure, it is preferable that the rubber composition further contains a carbon black with a nitrogen adsorption specific surface area of 110 m²/g or more and a carbon black with a nitrogen adsorption specific surface area of 80 m²/g or less.

This is because that it is possible to achieve more excellent steering stability.

In the tire of this disclosure, it is preferable that the rubber composition contains 50 mass % or more of a styrene-butadiene rubber of which the percentage of a bound styrene content among all polymer units +the percentage of a vinyl bond content among all polymer units×½ equals 25% or less.

This is because that it is possible to improve the braking performance on dry road surface and on wet road surface more securely.

### Advantageous Effect

According to this disclosure, it is possible to provide a tire having excellent braking performance on dry road surface and on wet road surface, and having excellent steering stability.

### BRIEF DESCRIPTION OF THE DRAWINGS

FIG. 1 is a partial development view illustrating a tread pattern of a tire according to an embodiment of this disclosure;

FIG. 2 is a partial development view illustrating a tread pattern of a tire according to another embodiment of this disclosure;

FIG. 3 schematically illustrates a cross section in the groove extending direction of the lug groove of the tread pattern in FIG. 1;

FIG. 4 is a partial development view illustrating a tread pattern of a tire as a sample of an example for this disclosure;

FIG. 5 is a partial development view illustrating a tread pattern of a tire as a sample of a comparative example; and

FIG. 6 is a partial development view illustrating a tread pattern of a tire as a sample of a comparative example.

### DETAILED DESCRIPTION

An embodiment of the tire of this disclosure will be described below with reference to the drawings.

The tire of this disclosure is a tire including a tread formed by using a rubber composition containing a rubber component and a thermoplastic resin.

Further, although not illustrated, the tire of this disclosure, as usual ones, may have a configuration having: a pair of bead portions; a carcass which is formed by a pair of sidewall portions continuous to tire radial outer sides of the bead portions and a tread portion extending between the sidewall portions, and extends toroidally across these portions between bead cores embedded in the bead portions; a belt formed by a plurality of belt layers arranged on a tire radial outer side of a crown portion of the carcass; and a tread disposed on a tire radial outer side of the belt.

<Structure of Tread>

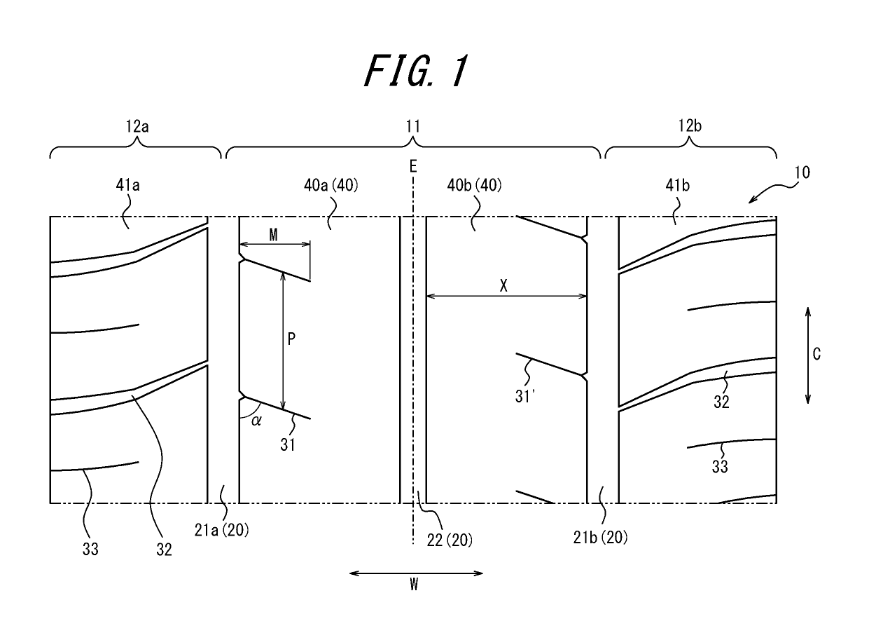

As illustrated in FIG. 1, the tread 10 constituting the tire of this disclosure has circumferential grooves 20 extending continuously in the tire circumferential direction C (extending linearly along the tire circumferential direction as for the example of FIG. 1), the negative ratio in the footprint (a ratio (%) of a footprint area of a groove part with respect to a footprint area of the tread 10) being 15% to 25%, the negative ratio derived from the circumferential grooves 20 (a ratio (%) of a footprint area of the circumferential grooves 20 to the footprint area of the tread 10) being 8% to 14%, and the negative ratio derived from the grooves other than the circumferential grooves (a ratio (%) of a footprint area of the grooves other than the circumferential grooves 20 with respect of the footprint area of the tread 10) being 7% to 11%.

By defining the negative ratio in the footprint of the tread within the aforementioned range, and specifically defining the ratio of the circumferential grooves among the negative ratio within the aforementioned range, it is possible to increase the land portion rigidity of the tread, and as a result, it is possible to achieve excellent steering stability as compared to conventional tires using to a tread a rubber composition containing a thermoplastic resin.

Here, the footprint of the tread 10 refers to the outer circumferential surface around the entire circumference of the tire, which contacts the road surface when the tire is rotated in a state mounted to an applicable rim with specified air pressure filled and a load corresponding to the maximum load capability applied.

Here, the “applicable rim” is a valid industrial standard for the region in which the tire is produced or used and refers to an approved rim of applicable size as described in the JATMA YEAR BOOK by JATMA (the Japan Automobile Tyre Manufacturers Association) in Japan, the STANDARDS MANUAL by ETRTO (the European Tyre and Rim Technical Organisation) in Europe, the YEAR BOOK by TRA (the Tire and Rim Association, Inc.) in the United States of America, and the like (Measuring Rim in the STANDARDS MANUAL by the ETRTO, and Design Rim in the YEAR BOOK by the TRA). Moreover, the “prescribed internal pressure” refers to an air pressure in accordance with the maximum load capability corresponding to the maximum load capability of the applicable size/ply rating described by the aforementioned JATMA, etc. The “maximum load capability” refers to the maximum mass that the tire is allowed to bear according to the aforementioned standards.

Here, the negative ratio in the footprint of the tread 10 is set to 15% to 25% because that in a tire using to a tread a specific rubber composition mentioned below, if the negative ratio is less than 15%, the negative ratio is excessively small, and thus there is a risk that necessary drainage performance and gripping performance cannot be ensured, while on the other hand, if the negative ratio is more than 25%, sufficient land portion rigidity of the tread cannot be obtained, and thus the desired steering stability cannot be ensured. Form the same viewpoint, it is preferable that the negative ratio in the footprint of the tread 10 is 20% to 25%.

Moreover, the negative ratio derived from the circumferential grooves 20 in the footprint is set to 8% to 14%, and the negative ratio derived from the grooves other than the circumferential grooves is set to 7% to 11%, because that in a tire using to a tread the specific rubber composition mentioned below, by setting the negative ratio derived from the circumferential grooves 20 within the aforementioned range, it is possible to improve the land portion rigidity of the tread. In the case where the negative ratio derived from the circumferential grooves 20 is less than 8%, or in the case where the negative ratio derived from the grooves other circumferential grooves is less than 7%, since the ratio of the land portion is increased, even if possible to ensure the land portion rigidity, necessary drainage performance and gripping performance cannot be ensured. On the other hand, in the case where the negative ratio derived from the circumferential grooves 20 is more than 14%, or in the case where the negative ratio derived from the grooves other circumferential grooves is more than 11%, sufficient land portion rigidity of the tread cannot be obtained, and thus the desired steering stability cannot be achieved.

From the same viewpoint, the negative ratio derived from the circumferential grooves 20 is preferably 10% to 14%, and the negative ratio derived from the grooves other than the circumferential grooves is 9% to 11%.

As illustrated in FIG. 1, the tread 10 may be divided into: a central region 11 partitioned by two circumferential grooves 21a, 21b located on tire widthwise outermost sides among the circumferential grooves 20; and two side regions 12a, 2b located on tire widthwise outer sides of the central region 11.

Here, borderlines between the central region 11 and the side regions 12a, 12b are widthwise centers of the two circumferential grooves 21a, 21b.

The central region 11 has a central land portion 40 (the central land portions 40a, 40b in the example of FIG. 1) formed by partitioning by the circumferential grooves 20 (the circumferential grooves 21a, 22, 21b in the example of FIG. 1), and the side regions 12a, 12b have side land portions 41a, 41b.

Here, it is preferable that the negative ratio of both the side regions 12a, 12b in the footprint is larger than the negative ratio of the central region 11 in the footprint. Since the rigidity of the central region 11 is important when considering improvement of the steering stability, by setting the negative ratio of the central region 11 to a small value, it is possible to achieve more excellent steering stability without deteriorating the drainage performance and the gripping performance.

A ratio of a total area of the central land portions 40a, 40b located in the central region 11 with respect to an area of the entire tire land portion on the footprint of the tread 10 (the central land portions 40a, 40b and the side land portions 41a, 41b in the example of FIG. 1) is preferably 40% to 60%, more preferably 50% to 60%. This is because that by setting the volume of the central region 11 to a large value, it is possible to increase the land portion rigidity, and to thereby obtain more excellent steering stability.

Moreover, from the point of obtaining the same effect, as illustrated in FIG. 1, an independent land portion width X of the central region 11 is preferably 1.5 times or more, more preferably 3 times or more of the groove depth of the circumferential groove 21b adjacent on the tire widthwise outer side. Here, as illustrated in FIG. 1, in the case where the central region 11 has two central land portions 40a, 40b separated in the tire width direction by the circumferential groove 22, an independent land portion width of the central region 11 refers to the width X of an independent central land portion (the central land portion 40b in the example of FIG. 1).

The number of the circumferential grooves 20 is not specifically limited. For example, it is possible to use one constituted by the two circumferential grooves 21a, 21b located on the tire widthwise outer sides and the one circumferential groove 22 located on the tire widthwise center as illustrated in FIG. 1, or increase the number of circumferential grooves 21 located on the tire widthwise outer sides and/or the number of the circumferential grooves 22 located on the tire widthwise center.

As illustrated in FIG. 1, it is preferable that the central land portions 40a, 40b have a plurality of widthwise narrow grooves 31, 31′ with a small groove width, which open to the circumferential grooves (the circumferential grooves 21a, 21b in the example of FIG. 1) and do not connect to another adjacent circumferential groove (the circumferential groove 22 in the example of FIG. 1). This is because that by disposing the widthwise narrow grooves 31, 31′ within the central land portion, it is possible to ensure the rigidity of the central region 11, and to simultaneously improve the braking performance when wet via a water film removal effect of each narrow groove 31, 31′.

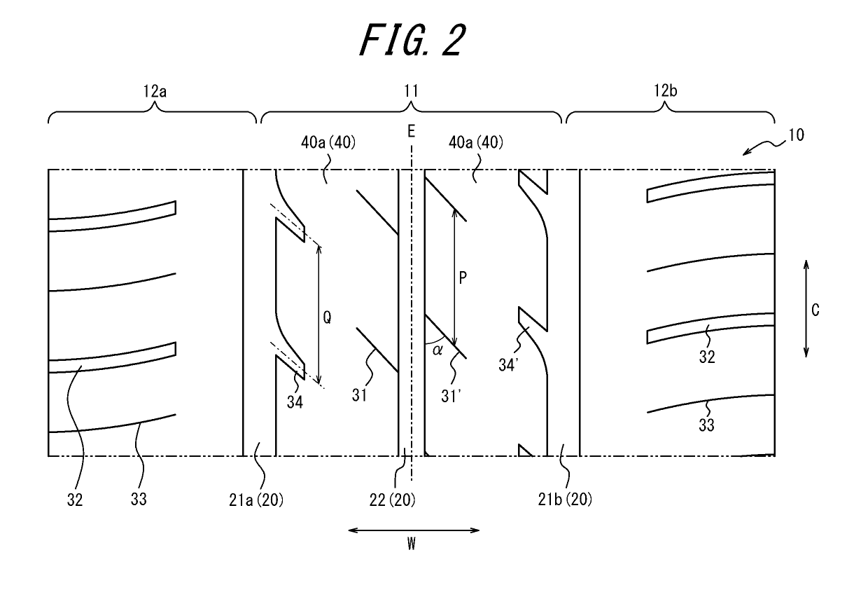

Here, the circumferential grooves to which the widthwise narrow grooves 31, 31′ open are not specifically limited. For example, it is possible to use one opening to the circumferential grooves 21a, 21b located on the tire widthwise outer sides as illustrated in FIG. 1, or one opening to the circumferential groove 22 located on the tire widthwise central side as illustrated in FIG. 2.

The widthwise narrow grooves 31, 31′ more preferably extend in a direction at 50° to 85° (i.e., an extension angle α with respect to the tire circumferential direction of the widthwise narrow groove satisfies 50°<α<85°, particularly preferably extend in a direction at 60° to 80° with respect to the tire circumferential direction C. This is because that it is possible to maintain the rigidity of the central region 11 at a high level, and to simultaneously improve the braking performance when wet via a water film removal effect of each narrow groove 31, 31′.

As illustrated in FIG. 1, it is preferable that the widthwise narrow grooves 31 are arranged alternately in the tire circumferential direction C with the widthwise narrow grooves 31′ extending oppositely across the tire equator E, the arranging interval P of the widthwise narrow grooves 31, 31′ opening to the same circumferential grooves 21a, 21b being 0.5% to 4.5% of the circumferential length of the tire equatorial plane on the tread surface. This is because that by arranging the widthwise narrow grooves 31 and the widthwise narrow grooves 31′ alternately across the tire equator E, it is possible to achieve both the braking performance when wet and the steering stability at a high level.

It is preferable that the widthwise narrow grooves 31, 31′ are comprised of sipes and/or notch grooves. Here, the sipes refer to ultra narrow grooves with a groove width (an opening width to the tread footprint; the same hereinafter) of 1.5 mm or less, and the notch grooves refer to narrow grooves with a groove width of 1.5 mm to 3.5 mm.

As illustrated in FIG. 1, a tire widthwise length M of the widthwise narrow grooves 31, 31′ is not specifically limited, but from the viewpoint of achieving both the braking performance when wet and the steering stability at a high level, the degree with respect to the land portion width X (M/X) is preferably within a range of 0.2≤M/X≤0.8, more preferably 0.3≤M/X≤0.7.

As illustrated in FIG. 2, the central region 11 may have lug grooves 34, 34′ other than the widthwise narrow grooves 31, 31′. In this case, regarding the lug grooves 34, 34′ arranged on the central region 11, similarly as the widthwise narrow grooves 31, 31′, the lug grooves 34 are arranged alternately in the tire circumferential direction C with the lug grooves 34′extending oppositely across the tire equator E, the arranging interval Q of the lug grooves 34, 34′ opening to the same circumferential grooves 21a, 21b being 0.5% to 4.5% of the circumferential length of the tread. Moreover, it is possible to have narrow widthwise grooves other than the lug grooves 34 as well.

As illustrated in FIG. 1, the side regions 12a, 12b may have lug grooves 32 and side region narrow grooves 33.

Here, it is preferable that the lug grooves 32 in FIG. 1 do not connect to the adjacent circumferential grooves 21a, 21b, or connect to the circumferential grooves 21a, 21b in a state where a part of the groove bottom is raised up. This is because that by configuring the lug grooves 32 as mentioned above, it is possible to obtain excellent braking performance, and to simultaneously ensure the land portion rigidity of the tread, and to thereby achieve the desired steering stability.

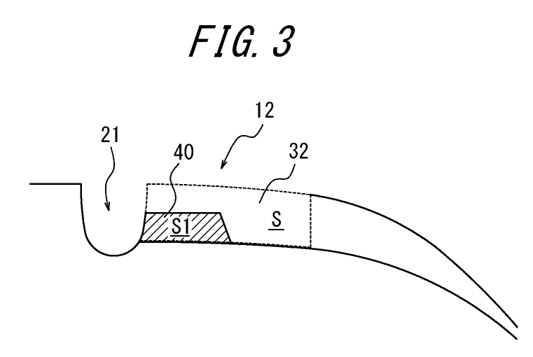

Here, in order to describe the configuration of the lug grooves 32, FIG. 3 schematically illustrate a cross section in a groove extension direction of the lug grooves 32 in FIG. 1. “The lug grooves 32 connect to the circumferential grooves 21a, 21b in a state where a part of the groove bottom is raised up” means that as illustrated in FIG. 3, the lug grooves 32 connect to the circumferential grooves 21a, 21b in a state where a part 40 in which the groove bottom of the lug grooves 32 is raised up is formed in a connecting part to the circumferential grooves 21.

In the case where the lug grooves 32 connect to the circumferential grooves 21a, 21b in a state where the groove bottom is raised up, as illustrated in FIG. 3, in the extension-direction cross section of the lug grooves 32, a ratio of a cross-section area S1 of the raised bottom part 40 to a cross-section area S of an entire lug groove 32 (SUS×100%) is preferably 20% or more, more preferably 30% or more. This is because that it is possible to ensure the land portion rigidity of the tread more securely even when lug grooves are disposed.

As illustrated in FIG. 1, it is preferable that a groove width of the lug grooves 32 is reduced from a tire widthwise outer side toward a tire widthwise central side. This is because that in the case where end portions of the lug grooves 32 are adjacent or connect to the circumferential grooves 21a, 21b, by reducing the groove width of the lug grooves 32 from the tire widthwise outer side to the tire widthwise central side, it is possible to ensure the land portion rigidity of the tread more securely even when lug grooves are disposed.

<Rubber Composition>

The tire of this disclosure has a tread formed with a rubber composition of which a tan δ at 0° C. is 0.25 to 0.55, a difference between a tan δ at 30° C. and a tan δ at 60° C. is −0.02 to 0.07, and a dynamic storage modulus at a dynamic strain of 1% and 0° C. is 4 MPa to 20 MPa. If the rubber composition has these physical properties, the obtained tread rubber is capable of achieving excellent braking performance on dry road surface and on wet road surface.

The rubber composition is not specifically limited as long as satisfying the aforementioned physical properties, but more specifically, the rubber composition is preferably a rubber composition containing: a rubber component A containing 50 mass % or more of a diene based rubber; and 5 to 50 parts by mass per 100 parts by mass of the rubber component of at least one additive component B selected from a thermoplastic resin, an oil or a low molecular weight aromatic vinyl compound-conjugated diene compound copolymer with a polystyrene-equivalent weight-average molecular weight of 5,000 to 200,000 measured by gel permeation chromatography.

By compounding a specific amount of the additive component B with respect to the rubber component A as mentioned above, it is possible to improve the grounding property of the tread rubber, and to improve the performances on wet road surface of the tire. Moreover, since the additive component B has a particularly high compatibility with natural rubber or diene based rubbers such as butadiene rubber, it is particularly easy to obtain its compounding effect in rubber component A rubber composition containing 50 mass % or more of a diene based rubber. Moreover, the rubber component itself has a high softness by containing 50 mass % or more of a diene based rubber, and thus is capable of achieving high braking performance on dry road surface and on slippery road surface such as manhole and the like.

The rubber component A contains 50 mass % or more, preferably 70 mass % or more, more preferably 80 mass % or more of a diene based rubber. By setting the diene based rubber content to 50 mass % or more in the rubber component, the effect of thermoplastic resin compounding mentioned below is sufficiently exhibited.

Here, the diene based rubber is not specifically limited, and is exemplified as natural rubber, styrene-butadiene rubber, isoprene rubber, butadiene rubber, chloroprene rubber, acrylonitrile-butadiene rubber, isobutylene-isoprene rubber, etc., but among these, from the viewpoint of achieving more excellent braking performance, it is preferable to use natural rubber or butadiene rubber. Here, the diene based rubber may be used singly or in a combination of a plurality. Furthermore, it is more preferable to contain 40 mass % or more of the natural rubber, particularly preferable to contain 70 mass % or more of the natural rubber.

It is preferable that the rubber component A contains a styrene-butadiene rubber (SBR). This is because that by compounding with SBR, it is possible to raise the glass transition temperature (Tg) of the rubber composition, and to thereby improve the steering stability on dry road surface and the braking performance.

Furthermore, it is preferable that the rubber composition uses as the SBR an SBR of which the percentage of a styrene bound content among all polymer units+the percentage of a vinyl bond content among all polymer units×½ equals 25 mass % or less. If the percentage of the styrene bound content and the percentage of the vinyl bond content within all polymer units satisfy the aforementioned correlation, it is possible to further improve the wet performance of the rubber composition, and to thereby further improve the braking performance on dry road surface and on wet road surface of the tire.

The thermoplastic resin contained as the additive component B in the rubber composition is not specifically limited. By using a thermoplastic resin, the loss tangent (tan δ) at 0° C. is raised, and thus it is possible to improve mainly the performances on wet road surface of the tire. In the case where the rubber component contains a large amount of natural rubber, since the thermoplastic resin has a high compatibility with the natural rubber, it is particularly easy to obtain the aforementioned performance improvement effect on wet road surface.

From the viewpoint of further improvement of the braking performance on dry road surface and on wet road surface, it is preferable that the thermoplastic resin is a C5 based resin, a C9 based resin, a C5 to C9 based resin, a dicyclopentadiene based resin, a rosin based resin, an alkylphenol based resin, or a terpenephenol based resin. These thermoplastic resins may be used singly or in a combination of a plurality.

Here, the C5 based resin refers to a C5 based synthetic petroleum resin, which is a solid polymer obtained by polymerizing a C5 fraction using a catalyst for the Friedel-Crafts reaction, such as AlCl₃, BF₃ and the like. Specific examples thereof may include: a copolymer including, as main components, isoprene, cyclopentadiene, 1,3-pentadiene, and 1-pentene; a copolymer of 2-pentene and dicyclopentadiene; a polymer mainly composed of 1,3-pentadiene, etc.

Here, the C9 based resin refers to a C9 based synthetic petroleum resin, which is a solid polymer obtained by polymerizing a C9 fraction using a catalyst for the Friedel-Crafts reaction, such as AlCl₃, BF₃ and the like. Specific examples thereof may include a copolymer including, as main components, indene, methylindene, α-methylstyrene, vinyltoluene, etc.

The C5 to C9 based resin refers to a C5 to C9 based synthetic petroleum resin, which is a solid polymer obtained by polymerizing a C5 to C9 fraction using a catalyst for the Friedel-Crafts reaction, such as AlCl₃, BF₃ and the like. Specific examples thereof may include a copolymer including, as main components, styrene, vinyltoluene, α-methylstyrene, indene, etc. In this disclosure, from the viewpoint of the compatibility with the rubber component, this C5 to C9 resin is preferably a resin with a small amount of a component of C9 or more. Here, “a small amount of a component of C9 or more” means that the component of C9 or more is less than 50 mass %, preferably 40 mass % or less in the entire amount of the resin.

The dicyclopentadiene based resin refers to a petroleum resin using the dicyclopentadiene in the C5 fraction as a main raw material. Specific examples thereof include trade name “Marcarez M” series (M-890A, M-845A, M-990A, etc.), made by Maruzen Petrochemical Co., Ltd.

The rosin resin include: natural resin rosins such as gum rosin, tall oil rosin and wood rosin contained in raw rosin or tall oil; modified rosin, rosin derivative and modified rosin derivative such as polymerized rosin, partially hydrogenated rosin thereof; glycerin ester rosin, partially hydrogenated rosin and completely hydrogenated rosin thereof; pentaerythritol ester rosin, partially hydrogenated rosin and polymerized rosin thereof, etc.

The alkylphenol based resin refers to a phenol based resin having an alkyl group. Examples thereof include alkylphenol-acetylene resin such as p-tert-butylphenol-acetylene resin, alkylphenol-formaldehyde resin with a low degree of polymerization, etc.

The terpene phenol based resin refers to a resin obtainable by reacting terpenoids and various phenols by using a Friedel-Crafts catalyst, or further condensing the same with formalin. Terpenoids for use as the material are not particularly limited, and may preferably be a monoterpene hydrocarbon such as α-pinenes and limonenes, more preferably terpenoids including α-pinenes, and particularly preferably be α-pienes. In this disclosure, terpene-phenol based resin having a large ratio of phenol component is preferable.

It is preferable that the rubber composition contains a Novolak-type phenol resin. By containing a Novolak-type phenol resin, it is possible to raise the elastic modulus in the rubber composition and to thereby improve the steering stability without using a curing agent, and without deteriorating the wet performance.

The content of the thermoplastic resin in the rubber composition is 5 to 50 parts by mass per 100 parts by mass of the rubber component, but from the viewpoint of the capability of obtaining more excellent braking performance on dry road surface and on wet road surface, 10 to 30 parts by mass is preferable.

The oil contained as the additive component B in the rubber composition is not specifically limited. Examples for the oil may include: petroleum-based softeners such as aroma oil, paraffin oil, spindle oil, naphthene oil, MES, TDAE and SRAE; and plant-based softeners such as palm oil, castor oil, cottonseed oil and soybean oil. The oil to be compounded may preferably be in a liquid state at ordinary temperature such as 25° C. in view of handling easiness. Of those described above, for example, a petroleum-based softener such as aroma oil, paraffin oil and naphthene oil is preferred.

It is preferable that the additive component B contained in the rubber composition is a low molecular weight aromatic vinyl compound-conjugated diene compound copolymer with a polystyrene-equivalent weight-average molecular weight of 5,000 to 200,000 measured by gel permeation chromatography. By using an aromatic vinyl compound-conjugated diene compound copolymer with an average molecular weight of 5,000 to 200,000, it is possible to improve the softness of the rubber composition, and to achieve high braking performance on dry road surface and on slippery road surface such as manhole and the like. Further, in order to sufficiently improve the wet performance of the rubber composition, it is preferable that a content of the aromatic vinyl compound is 5 to 80 mass %, and a vinyl bonding amount of a conjugated diene compound moiety is 10 to 80 mass %.

The rubber composition may contain a filler other than the rubber component and the additive component B. By containing a filler (C), it is possible to achieve high reinforcement performance and low heat generating property without deteriorating the properties of the rubber, such as the softness.

A compounding amount of the filler in the rubber composition is not specifically limited, but is preferably 30 to 100 parts by mass, more preferably 40 to 80 parts by mass per 100 parts by mass of the rubber component. By setting the compounding amount of the filler to 30 to 100 parts by mass, it is possible to exhibit the reinforcing effect of the rubber component without deteriorating its properties such as the softness, and on the other hand, by setting the compounding amount of the filler to 40 to 80 parts by mass, in particular, it is possible to exhibit the effect of reduction of the rolling resistance and improvement of the braking performance on wet road surface, and to simultaneously decrease the probability of deteriorating the softness of the rubber component.

The type of the filler (C) is not specifically limited, and is exemplified as fillers such as silica, carbon black, aluminum oxide, clay, alumina, talc, mica, kaolin, glass balloon, glass beads, calcium carbonate, magnesium carbonate, magnesium hydroxide, calcium carbonate, magnesium oxide, titanium oxide, potassium titanate and barium sulfate.

Among the aforementioned filler (C), from the view point of exhibiting the effect of reduction of the rolling resistance and improvement of the braking performance on wet road surface, and simultaneously decreasing the probability of deteriorating the softness of the rubber component, it is preferable to use silica. By containing silica in the rubber composition, it is possible to apply sufficient reinforcement performance and low heat generating property to it in a state where the diene based rubber and the thermoplastic resin are well dispersed, without deteriorating its softness.

Examples of silica may include: wet silica (hydrous silica), dry silica (anhydrous silica), calcium silicate, aluminum silicate, with wet silica being suitably used in particular. This wet silica has BET specific surface area of preferably 40 m²/g to 350 m²/g. A silica within this range of BET specific surface area has the advantage of the capability of achieving both the rubber reinforcement performance and the dispersibility in the rubber component. From this viewpoint, a silica with a BET specific surface area of 80 m²/g to 300 m²/g is further preferable. Such silica may be commercially available ones, such as trade names “Nipsil AQ”, “Nipsil KQ”, made by Tosoh Silica

Corporation, and trade name “Ultrasil VN3”, made by Degussa AG. This silica may be used singly or in a combination of two or more.

Further, a compounding amount of the silica is preferably within a range of 40 to 70 parts by mass, more preferably within a range of 45 to 60 parts by mass per 100 parts by mass of the rubber component. If the compounding amount of the silica is 40 parts by mass or more per 100 parts by mass of the rubber component, tan δ at 60° C. of the rubber composition is reduced, which improves the fuel efficiency during ordinary running of a tire applied with the rubber composition. Moreover, if 70 parts by mass or less, the softness of the rubber composition is improved, and by applying the rubber composition to a tread rubber of a tire, a deformation volume of the tread rubber is increased, which enables improvement of the wet performance of the tire. Moreover, among the filler (C), if the silica is 50 mass % or more, preferably 70 mass % or more, further more preferably 90 mass % or more, the braking performance on wet road surface is further improved.

In the rubber composition of this disclosure, it is preferable that the filler (C) further contains a carbon black, and a compounding amount of the carbon black is preferably within a range of 1 to 10 parts by mass, more preferably within a range of 30 to 80 parts by mass per 100 parts by mass of the rubber component. By compounding the carbon black by 1 part by mass or more, the rigidity of the rubber composition is improved, and by compounding by 10 parts by mass or less, it is possible to suppress the increase of the loss tangent (tan δ). Therefore, by applying the rubber composition to a tread rubber of a tire, it is possible to achieve both the fuel efficiency and the wet performance of the tire at a high level. The carbon black is not specifically limited, and is exemplified as carbon blacks of GPF, FEF, HAF, ISAF, SAF grade. Among these, from the viewpoint of improving the wet performance of the tire, a carbon black of ISAF and SAF grade is preferable. These carbon blacks may be used singly or in a combination of two or more.

As the carbon black, it is preferable that the rubber composition further contains a carbon black with a nitrogen adsorption specific surface area of 110 m²/g or more and a carbon black with a nitrogen adsorption specific surface area of 80 m²/g or less. By compounding a carbon black with a nitrogen adsorption specific surface area of 110 m²/g or more, it is possible to ensure the wet performance at a high level, and by simultaneously compounding a carbon black with a nitrogen adsorption specific surface area of 80 m²/g or less, it is possible to ensure the elastic modulus of the tire, which enables improvement of the steering stability.

In the case where the rubber composition contains a silica as the filler, in order to further improve the reinforcement performance and the low heat generating property of the compounded silica, it is preferable to further contain a silane coupling agent.

Examples of the silane coupling agent may include:
bis(3-triethoxysilylpropyl)tetrasulfide, bis(3-triethoxysilylpropyl)trisulfide,
bis(3-triethoxysilylpropyl)disulfide, bis(2-triethoxysilylethyl)tetrasulfide,
bis(3-trimethoxysilylpropyl)tetrasulfide,
bis(2-trimethoxysilylethyl)tetrasulfide, 3-mercaptopropyltrimethoxysilane,
3-mercaptopropyltriethoxysilane, 2-mercaptoethyltrimethoxysilane,
2-mercaptoethyltriethoxysilane,
3-trimethoxysilylprpopyl-N,N-dimethylthiocarbamoyltetrasulfide,
3-triethoxysilylprpopyl-N,N-dimethylthiocarbamoyltetrasulfide,
2-triethoxysilylethyl-N,N-dimethylthiocarbamoyltetrasulfide,
3-trimethoxysilylpropylbenzothiazyltetrasulfide,
3-triethoxysilylpropylbenzolyltetrasulfide,
3-triethoxysilylpropylmethacrylatemonosulfide,
3-trimethoxysilylpropylmethacrylatemonosulfide,
bis(3-diethoxymethylsilylpropyl)tetrasulfide,
3-mercaptopropyldimethoxymethylsilane,
dimethoxymethylsilylpropyl-N,N-dimethylthiocarbamoyltetrasulfide,
dimethoxymethylsilylpropylbenzothiazolyltetrasulfide, among which
bis(3-triethoxysilylpropyl)trisulfide and
3-trimethoxysilylpropylbenzothiazoletetrasulfide are suited for use in view of the reinforcement improving effect.

These silane coupling agents may be used singly or in a combination of two or more.

A preferred content of the silane coupling agent in the rubber composition differs depending on the type of the silane coupling agent, but is preferably selected within a range of 2 to 25 mass % with respect to the silica.

When the amount is less than 2 mass %, the silane coupling agent fails to fully exhibit the effect thereof, and when more than 25 mass %, there is a risk of causing gelation of the rubber component.

From the viewpoint of the effect as a coupling agent and gelation prevention, the content of this silane coupling agent is preferably within a range of 2 to 20 mass %, further preferably 5 to 18 mass %, particularly preferably 5 to 15 mass %.

The disclosed rubber composition may be compounded with, in addition to the aforementioned rubber component, thermoplastic resin and filler, other compounding agents generally used in the rubber industry, such as, for example, antioxidant, vulcanization accelerator, a vulcanization accelerator aid, and vulcanizing agent, which may be selected as appropriate without affecting the object of the present disclosure, within a range of general amount. Commercially available products may be suitably used as these additives. Further, the rubber composition can be manufactured with a well-known method, for example, by compounding the rubber components with the thermoplastic resin, the filler and various additives appropriately selected as necessary, and subjecting the same to kneading, warming, extrusion, etc.

The method for using the rubber composition to the tread rubber may be a well-known method as well. For example, it is possible to use the aforementioned rubber composition to the tread rubber to form a raw tire, and to manufacture a tire by vulcanizing the raw tire with a usual method.

### EXAMPLES

This disclosure will be explained in further details in the following according to examples, while this disclosure is not limited to the following examples.

### Example 1

(Samples 1 to 31)

Rubber compositions were prepared according to the formulations shown in Table 1. The rubber compositions thus prepared were each used as the tread rubber to fabricate, with a general method, a radial tire in a size of 195/65R15 for a passenger vehicle. Here, the tread pattern of the fabricated tire used the one as illustrated in FIG. 1.

Further, the loss tangent (tan δ) and the storage modulus (E′) of the tread rubbers using each rubber composition were measured according to the following conditions. By collecting specimens of 50mm×5mm×2mm from the tread portion of the tire, by using a spectrometer made by Ueshima Seisakusho Co., Ltd., the loss tangent (tan δ) at 0° C., 30° C. and 60° C. and the storage modulus (E′) at 0° C. were measured at the conditions of initial strain: 2%, dynamic strain: 1%, and frequency: 52 Hz. The measurement results were as shown shown in Table 1.

(Evaluation)

Each sample of the obtained radial tires for passenger vehicle was subjected to the following evaluation. The evaluation results were as shown in Table 1.

(1) Braking Performance on Steel-Plate Wet Road Surface

Four test tires were mounted onto a passenger vehicle of 2000 cc displacement. The passenger vehicle was run on a steel-plate wet road evaluation path as a test course. Then, the vehicle was braked at the speed of 40 km/h to lock the tires, so as to measure the distance it took to stop. The results thereof were indexed using the numeric value of Control Tire (comparative example) as 100 as to the inverse of the distance. A larger index value shows more excellent performance on a steel-plate wet road surface.

(2) Braking Performance on Dry Road Surface

Four test tires were mounted onto a passenger vehicle of 2000 cc displacement. The passenger vehicle was run on an asphalt evaluation path as a test course. Then, the vehicle was braked at the speed of 80 km/h to lock the tires, so as to measure the distance it took to stop. The results thereof were indexed using the numeric value of Control Tire (Sample 1: comparative example) as 100 as to the inverse of the distance. A larger index value shows more excellent performance on a dry road surface.

(3) Rolling Resistance

The rolling resistance of each tire in a size of 195/65R15 was measured by rolling on a rotating drum at a speed of 80 km/hr, with a load of 4.41 kN applied. The results thereof were indexed using the inverse of the rolling resistance of Control Tire (Sample 1: comparative example) as 100. A larger index value shows a low rolling resistance and more excellent rolling resistance performance.

(4) Steering Stability

The handling performance of each sample tire was evaluated with an actual vehicle test on dry road surface, based on feeling of a test driver. The results thereof were indexed using the dry performance of Control Tire (Sample 1: comparative example) as 100, where a larger index value shows excellent handling performance and excellent steering stability.

TABLE 1

| | | No. | | | | | | | | | | |
|---|---|---|---|---|---|---|---|---|---|---|---|---|
| | | 1 | 2 | 3 | 4 | 5 | 5 | 6 | 7 | 8 | 9 | 10 |
| | | Compar- | Inven- | Inven- | Inven- | Compar- | Compar- | Inven- | Inven- | Compar- | Inven- | Inven- |
| | | ative | tive | tive | tive | ative | ative | tive | tive | ative | tive | tive |
| | | exam- | exam- | exam- | exam- | exam- | exam- | exam- | exam- | exam- | exam- | exam- |
| | | ple | ple | ple | ple | ple | ple | ple | ple | ple | ple | ple |
| Rubber | BR | 30 | 70 | 70 | 100 | — | — | — | 40 | 60 | — | — |
| compo- | NR | 70 | 30 | 30 | — | — | — | — | — | — | 100 | 100 |
| sition | SBR | — | — | — | — | — | — | — | — | — | — | — |
| formu- | SBR1 *¹ | — | 15 | 30 | 30 | — | 100 | — | — | — | — | — |
| lation | Low Tg SBR *² | — | — | — | — | 100 | | 100 | 60 | 40 | — | — |
| (Parts | CB ISAF *³ | 48 | 8 | 8 | 8 | 48 | 48 | 8 | 8 | 8 | 8 | 8 |
| by mass) | CB HAF *⁴ | — | — | — | — | — | — | — | — | — | — | — |
| | Silica *⁵ | 32 | 72 | 72 | 72 | 32 | 32 | 72 | 50 | 50 | 72 | 72 |
| | Aromatic oil | — | 10 | 10 | 10 | 10 | 10 | 10 | 5 | 5 | 10 | 20 |
| | Process oil 1 *⁶ | — | — | — | — | — | — | — | — | — | — | — |
| | Spindle oil | — | — | — | — | — | — | — | — | — | — | — |
| | Process oil 2 *⁷ | — | — | — | — | — | — | — | — | — | — | — |
| | Sunflower oil | — | — | — | — | — | — | — | — | — | — | — |
| | Palm oil *⁸ | — | — | — | — | — | — | — | — | — | — | — |
| | C [symbol] based resin *⁹ | — | — | — | — | — | — | — | — | — | — | — |
| | C [symbol] to C [symbol] | — | — | — | — | — | — | — | — | — | — | — |
| | based resin *¹⁰ | | | | | | | | | | | |
| | C [symbol] based | — | — | — | — | — | — | — | — | — | — | — |
| | resin *¹¹ | | | | | | | | | | | |
| | Terpene-phenol | — | — | — | — | — | — | — | — | — | — | — |
| | based resin *¹² | | | | | | | | | | | |
| | Novolak-type | — | — | — | — | — | — | — | — | — | — | — |
| | phenol resin *¹³ | | | | | | | | | | | |
| | Stearic acid | 2 | 2 | 2 | 2 | 2 | 2 | 2 | 2 | 2 | 2 | 2 |
| | Age resistor 6PPD | 1 | 1 | 1 | 1 | 1 | 1 | 1 | 1 | 1 | 1 | 1 |
| | Zinc oxide | 2 | 2 | 2 | 2 | 2 | 2 | 2 | 2 | 2 | 2 | 2 |
| | Vulcanization | 0.8 | 0.8 | 0.8 | 0.8 | 0.8 | 0.8 | 0.8 | 0.8 | 0.8 | 0.8 | 0.8 |
| | accelerator DPG | | | | | | | | | | | |
| | Sulfur | 1 | 1 | 1 | 1 | 1 | 1 | 1 | 1 | 1 | 1 | 1 |
| Ratio of silica in filler (%) | | 40 | 90 | 90 | 90 | 40 | 40 | 90 | 86 | 86 | 90 | 90 |
| Total filler compounding | | 80 | 80 | 80 | 80 | 80 | 80 | 80 | 58 | 58 | 80 | 80 |
| amount (parts by mass) | | | | | | | | | | | | |
| Physical | 0° C. tanδ | 0.38 | 0.4 | 0.411 | 0.390 | 0.560 | 0.701 | 0.402 | 0.356 | 0.310 | 0.400 | 0.450 |
| properties | 30° C. tanδ | 0.252 | 0.185 | 0.201 | 0.185 | 0.268 | 0.313 | 0.194 | 0.192 | 0.173 | 0.201 | 0.213 |
| | 60° C. tanδ | 0.21 | 0.165 | 0.170 | 0.180 | 0.212 | 0.230 | 0.156 | 0.147 | 0.135 | 0.170 | 0.174 |
| | 30° C. tanδ − | 0.042 | 0.020 | 0.031 | 0.005 | 0.056 | 0.083 | 0.038 | 0.045 | 0.038 | 0.031 | 0.039 |
| | 60° C. tanδ | | | | | | | | | | | |
| | 0° C. E [symbol] (Mpa) | 21.2 | 13.0 | 14.3 | 13.5 | 18.5 | 25.0 | 18.4 | 19.0 | 22.0 | 14.3 | 12.8 |
| Tire | Braking performance | 100 | 106 | 109 | 106 | 110 | 115 | 112 | 110 | 105 | 109 | 109 |
| perfor- | on steel-plate | | | | | | | | | | | |
| mance | wet road surface | | | | | | | | | | | |
| | Braking perfo [symbol] e | 100 | 100 | 101 | 100 | 103 | 105 | 101 | 101 | 97 | 102 | 102 |
| | on dry road | | | | | | | | | | | |
| | surface | | | | | | | | | | | |
| | Rolling Resistance | 100 | 107 | 106 | 105 | 97 | 94 | 109 | 110 | 103 | 106 | 105 |
| | Steering stability | 100 | 102 | 103 | 103 | 106 | 106 | 106 | 107 | 105 | 103 | 102 |

| | | No. | | | | | | | | | | |
|---|---|---|---|---|---|---|---|---|---|---|---|---|
| | | 11 | 12 | 13 | 14 | 15 | 16 | 17 | 18 | 19 | 20 | 21 |
| | | Inven- | Inven- | Inven- | Inven- | Inven- | Inven- | Inven- | Inven- | Inven- | Inven- | Inven- |
| | | tive | tive | tive | tive | tive | tive | tive | tive | tive | tive | tive |
| | | exam- | exam- | exam- | exam- | exam- | exam- | exam- | exam- | exam- | exam- | exam- |
| | | ple | ple | ple | ple | ple | ple | ple | ple | ple | ple | ple |
| Rubber | BR | — | 30 | — | — | — | — | — | — | — | 30 | 30 |
| compo- | NR | 100 | 70 | 100 | 100 | 100 | 100 | 100 | 100 | 100 | 70 | 70 |
| sition | SBR | — | — | — | — | — | — | — | — | — | — | — |
| formu- | SBR1 *¹ | — | — | — | — | — | — | — | — | — | — | — |
| lation | Low Tg SBR *² | — | — | — | — | — | — | — | — | — | — | — |
| (Parts | CB ISAF *³ | 8 | 8 | 8 | 8 | 8 | 8 | 8 | 5 | 5 | 40 | 32 |
| by mass) | CB HAF *⁴ | — | — | — | — | — | — | — | — | — | — | — |
| | Silica *⁵ | 72 | 72 | 72 | 72 | 72 | 72 | 72 | 50 | 50 | 40 | 48 |
| | Aromatic oil | 45 | 10 | — | — | — | — | — | 2 | 2 | — | — |
| | Process oil 1 *⁶ | — | — | 20 | — | — | — | — | — | — | — | — |
| | Spindle oil | — | — | — | 20 | — | — | — | — | — | — | — |
| | Process oil 2 *⁷ | — | — | — | — | 20 | — | — | — | — | — | — |
| | Sunflower oil | — | — | — | — | — | 20 | — | — | — | — | — |
| | Palm oil *⁸ | — | — | — | — | — | — | 20 | — | — | — | — |
| | C [symbol] based resin *⁹ | — | — | — | — | — | — | — | 15 | — | 15 | 15 |
| | C [symbol] to C [symbol] | — | — | — | — | — | — | — | — | — | — | — |
| | based resin *¹⁰ | | | | | | | | | | | |
| | C [symbol] based | — | — | — | — | — | — | — | — | 15 | — | — |
| | resin *¹¹ | | | | | | | | | | | |
| | Terpene-pheuol | — | — | — | — | — | — | — | — | — | — | — |
| | based resin *¹² | | | | | | | | | | | |
| | Novolak-type | — | — | — | — | — | — | — | — | — | — | — |
| | phenol resin *¹³ | | | | | | | | | | | |
| | Stearic acid | 2 | 2 | 2 | 2 | 2 | 2 | 2 | 2 | 2 | 2 | 2 |
| | Age resistor 6PPD | 1 | 1 | 1 | 1 | 1 | 1 | 1 | 1 | 1 | 1 | 1 |
| | Zinc oxide | 2 | 2 | 2 | 2 | 2 | 2 | 2 | 2 | 2 | 2 | 2 |
| | Vulcanization | 0.8 | 0.8 | 0.8 | 0.8 | 0.8 | 0.8 | 0.8 | 0.8 | 0.8 | 0.8 | 0.8 |
| | accelerator DPG | | | | | | | | | | | |
| | Sulfur | 1 | 1 | 1 | 1 | 1 | 1 | 1 | 1 | 1 | 1 | 1 |
| Ratio of silica in filler (%) | | 90 | 90 | 90 | 90 | 90 | 90 | 90 | 91 | 91 | 50 | 60 |
| Total filler compounding | | 80 | 80 | 80 | 80 | 80 | 80 | 80 | 55 | 55 | 80 | 80 |
| amount (parts by mass) | | | | | | | | | | | | |
| Physical | 0° C. tanδ | 0.480 | 0.362 | 0.412 | 0.405 | 0.409 | 0.420 | 0.415 | 0.356 | 0.360 | 0.398 | 0.410 |
| properties | 30° C. tanδ | 0.225 | 0.183 | 0.195 | 0.192 | 0.194 | 0.199 | 0.196 | 0.171 | 0.205 | 0.249 | 0.230 |
| | 60° C. tanδ | 0.183 | 0.148 | 0.159 | 0.157 | 0.158 | 0.163 | 0.161 | 0.121 | 0.170 | 0.202 | 0.185 |
| | 30° C. tanδ − | 0.042 | 0.035 | 0.035 | 0.035 | 0.035 | 0.036 | 0.036 | 0.050 | 0.035 | 0.047 | 0.045 |
| | 60° C. tanδ | | | | | | | | | | | |
| | 0° C. E [symbol] (Mpa) | 9.4 | 12.6 | 12.5 | 11.5 | 11.8 | 11.6 | 12.0 | 9.7 | 13.4 | 17.9 | 16.0 |
| Tire | Braking performance | 110 | 105 | 106 | 107 | 106 | 106 | 106 | 102 | 105 | 112 | 110 |
| perfor- | on steel-plate | | | | | | | | | | | |
| mances | wet road surface | | | | | | | | | | | |
| | Braking perfo [symbol] e | 102 | 100 | 101 | 100 | 101 | 101 | 101 | 100 | 102 | 102 | 102 |
| | on dry road | | | | | | | | | | | |
| | surface | | | | | | | | | | | |
| | Rolling Resistance | 104 | 109 | 108 | 109 | 108 | 107 | 108 | 110 | 106 | 100 | 101 |
| | Steering stability | 100 | 102 | 101 | 100 | 101 | 101 | 101 | 100 | 102 | 100 | 100 |

| | | No. | | | | | | | | | |
|---|---|---|---|---|---|---|---|---|---|---|---|
| | | 22 | 23 | 24 | 25 | 26 | 27 | 28 | 29 | 30 | 31 |
| | | Inven- | Inven- | Inven- | Inven- | Inven- | Inven- | Inven- | Inven- | Inven- | Inven- |
| | | tive | tive | tive | tive | tive | tive | tive | tive | tive | tive |
| | | exam- | exam- | exam- | exam- | exam- | exam- | exam- | exam- | exam- | exam- |
| | | ple | ple | ple | ple | ple | ple | ple | ple | ple | ple |
| Rubber | BR | 30 | — | — | — | 30 | — | — | — | 30 | 30 |
| compo- | NR | 70 | 100 | 85 | 85 | 70 | 100 | 85 | 100 | 70 | 70 |
| sition | SBR | — | — | 15 | 15 | — | — | 15 | — | — | — |
| formu- | SBR1 *¹ | — | — | — | — | — | — | — | — | — | — |
| lation | Low Tg SBR *² | — | — | — | — | — | — | — | — | — | — |
| (Parts | CB ISAF *³ | 8 | 8 | 8 | 8 | 40 | 8 | 8 | 8 | 8 | 16 |
| by mass) | CB HAF *⁴ | — | — | — | — | — | — | — | — | — | 16 |
| | Silica *⁵ | 72 | 72 | 72 | 72 | 40 | 72 | 72 | 72 | 72 | 48 |
| | Aromatic oil | — | — | — | — | — | — | — | — | — | — |
| | Process oil 1 *⁶ | — | — | — | — | — | — | — | — | — | — |
| | Spindle oil | — | — | — | — | — | — | — | — | — | — |
| | Process oil 2 *⁷ | — | — | — | — | — | — | — | — | — | — |
| | Sunflower oil | — | — | — | — | — | — | — | — | — | — |
| | Palm oil *⁸ | — | — | — | — | — | — | — | — | — | — |
| | C [symbol] based resin *⁹ | 15 | 5 | — | — | — | — | — | — | — | — |
| | C [symbol] to C [symbol] | — | — | 15 | — | — | — | — | — | — | — |
| | based resin *¹⁰ | | | | | | | | | | |
| | C [symbol] based | — | — | — | — | 15 | 15 | 15 | 30 | 15 | 15 |
| | resin *¹¹ | | | | | | | | | | |
| | Terpene-phenol | — | — | — | 15 | — | — | — | — | — | — |
| | based resin *¹² | | | | | | | | | | |
| | Novolak-type | — | — | — | — | — | — | — | — | 4 | — |
| | phenol resin *¹³ | | | | | | | | | | |
| | Stearic acid | 2 | 2 | 2 | 2 | 2 | 2 | 2 | 2 | 2 | 2 |
| | Age resistor 6PPD | 1 | 1 | 1 | 1 | 1 | 1 | 1 | 1 | 1 | 1 |
| | Zinc oxide | 2 | 2 | 2 | 2 | 2 | 2 | 2 | 2 | 2 | 2 |
| | Vulcanization | 0.8 | 0.8 | 0.8 | 0.8 | 0.8 | 0.8 | 0.8 | 0.8 | 0.8 | 0.8 |
| | accelerator DPG | | | | | | | | | | |
| | Sulfur | 1 | 1 | 1 | 1 | 1 | 1 | 1 | 1 | 1 | 1 |
| Ratio of silica in filler (%) | | 90 | 90 | 90 | 90 | 50 | 90 | 90 | 90 | 90 | 75 |
| Total filler compounding | | 80 | 80 | 80 | 80 | 80 | 80 | 80 | 80 | 80 | 80 |
| amount (parts by mass) | | | | | | | | | | | |
| Physical | 0° C. tanδ | 0.369 | 0.334 | 0.426 | 0.412 | 0.389 | 0.398 | 0.408 | 0.499 | 0.317 | 0.411 |
| properties | 30° C. tanδ | 0.215 | 0.22 | 0.244 | 0.260 | 0.253 | 0.255 | 0.282 | 0.294 | 0.256 | 0.24 |
| | 60° C. tanδ | 0.165 | 0.17 | 0.190 | 0.207 | 0.209 | 0.207 | 0.230 | 0.245 | 0.199 | 0.18 |
| | 30° C. tanδ − | 0.050 | 0.050 | 0.054 | 0.053 | 0.044 | 0.048 | 0.052 | 0.049 | 0.057 | 0.060 |
| | 60° C. tanδ | | | | | | | | | | |
| | 0° C. E [symbol] (Mpa) | 13.9 | 17.4 | 17.2 | 19.5 | 18.8 | 18.5 | 19.3 | 15.3 | 20.0 | 15.1 |
| Tire | Braking performance | 106 | 109 | 112 | 117 | 117 | 114 | 117 | 117 | 114 | 110 |
| perfor- | on steel-plate | | | | | | | | | | |
| mances | wet road surface | | | | | | | | | | |
| | Braking perfo [symbol] e | 102 | 99 | 100 | 101 | 101 | 104 | 105 | 103 | 104 | 103 |
| | on dry road | | | | | | | | | | |
| | surface | | | | | | | | | | |
| | Rolling Resistance | 106 | 104 | 102 | 102 | 102 | 103 | 101 | 100 | 101 | 104 |
| | Steering stability | 102 | 104 | 101 | 101 | 105 | 107 | 109 | 102 | 108 | 104 |

*¹ SBR1 was produced under the following production conditions.
Charging a cyclohexane solution of butadiene (16%) and a cyclohexane solution of styrene (21%) in a dry, nitrogen-substituted pressure-resistant glass vessel (800 mL), such that butadiene monomer is 40 g and styrene monomer is 10 g; adding 0.66 mmol of 2,2-di(tetrahydrofuryl)propane, and adding 1.32 mmol of n-butyllithium (BuLi) thereto; then polymerizing in a warm bath at 50° C. for 1.5 hours. The polymerization conversion rate was approximately 100%. Then, further adding 0.5 ml of a 5 mass % isopropanol solution of 2,6-di-t-butylparacresol (BHT), to stop the reaction. Then, drying by a conventional method to obtain liquid SBR1.
As a result obtained by measuring the weight-average molecular weight (Mw) through gel permeation chromatography [GPC: HLC-8020, made by Tosoh Corporation, column: two of GMH-XL connected in series, made by Tosoh Corporation, detector: a differential refractometer (RI)], using monodisperse polystyrene as a reference, a polystyrene-equivalent weight-average molecular weight of the obtained liquid SBR1 was 80,000.
Moreover, as a result of determining the microstructure by infrared spectroscopy (Morello), and determining the bound styrene content from an integral ratio of 1H-NMR spectrum, the obtained liquid SBR1 had a bound styrene content of 25 mass % and a vinyl bond content of the butadiene moiety of 65 mass %.
*² product name: “SL584”, made by JSR Corporation, styrene 5 mass %, vinyl 28 mass %
*³ trade name: “#80”, made by Asahi Carbon Co., Ltd., N²SA 115 m²/g, N220 (ISAF)
*⁴ trade name: “#77”, made by Asahi Carbon Co., Ltd., N²SA 115 m²/g, N330 (ISAF)
*⁵ trade name “Nipsil AQ”, made by Tosoh Silica Corporation
*⁶ product name “A/O MIX”, made by JX Nippon Oil & Energy Corporation
*⁷ “TDAE”, made by JX Nippon Oil & Energy Corporation
*⁸ palm oil, made by Nisshin Oillio
*⁹ trade name “ECR1102”, made by ExxonMobil Chemical Company
*¹⁰ trade name “ECR213”, made by ExxonMobil Chemical Company
*¹¹ trade name “Nisseki Neopolymer ® 140” (Nisseki Neopolymer is a registered trademark in Japan, other countries, or both), made by JX Nippon Oil & Energy Corporation
*¹² trade name “YS Polystar T100”, made by Yasuhara Chemical Co., Ltd.
*¹³ sumilite resin “PR50235”, made by Sumitomo Bakelite Co., Ltd. [symbol]
indicates data missing or illegible when filed

From the results in Table 1, it was understood that each example of this disclosure obtained results equal to or better than the comparative examples. From the comparison between the comparative examples and this disclosure, it was understood that by increasing the silica compounding ratio in the filler, it is possible to particularly improve the braking performance on steel-plate wet road surface.

### Example 2

(Sample 1 to 10)

Next, samples of tires (size: 195/65R15) having treads under the conditions in Table 2 were produced experimentally.

The condition of the negative ratio in the contact patch of the tread (inclusive of the negative ratio derived from circumferential groove), the condition of the central region (the ratio of the central region, the independent land portion width, and the conditions of the lug grooves and the narrow grooves (the widthwise narrow grooves)) and the condition of the side regions (the condition of the lug grooves) of each sample was as shown in Table 1.

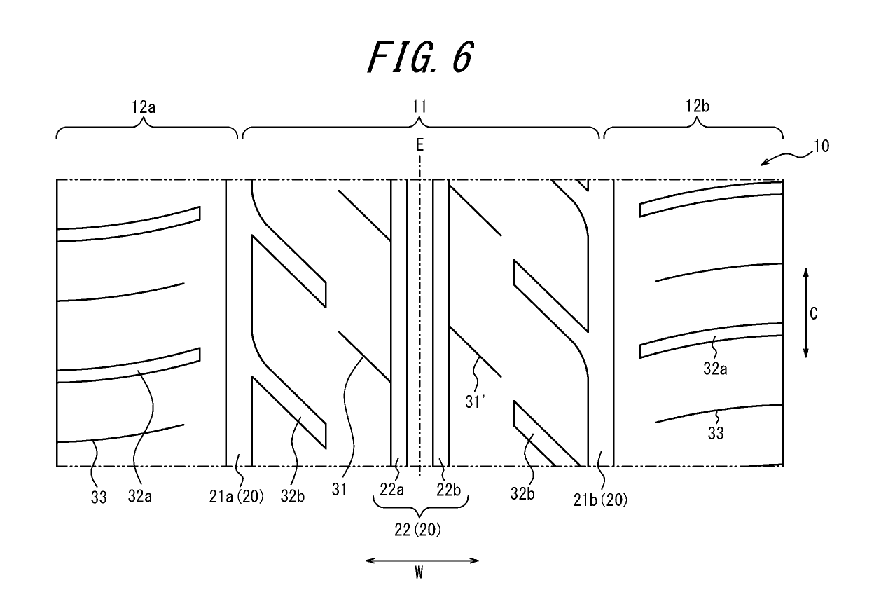

Further, the outline of the treads of each sample was as illustrated in FIGS. 1 to 6.

Moreover, each of the rubber compositions used in the treads of each sample was prepared according to Formulation A in Table 4.

(Sample 11 to 20)

Moreover, samples of tires (size: 195/65R15) having treads under the conditions in Table 3 were produced experimentally.

The condition of the negative ratio in the contact patch of the tread (inclusive of the negative ratio derived from circumferential groove), the condition of the central region (the ratio of the central region, the independent land portion width, and the conditions of the lug grooves and the narrow grooves (the widthwise narrow grooves)) and the condition of the side regions (the condition of the lug grooves) of each sample was as shown in Table 1.

Further, the outline of the treads of each sample was as illustrated in FIGS. 1 to 6.

Moreover, each of the rubber compositions used in the treads of each sample was prepared according to Formulation B in Table 4.

(Evaluation)

Samples 1 to 20 were subjected to the following evaluation. The evaluation results were as shown in Tables 2 and 3.

(1) Cornering Power Index

The cornering force of each sample when the slip angle is 1° was measured in a state mounted to an approved rim at an air pressure of 230 kPa, and applied with a load of 4.22 kN.

The results thereof were indexed using as 100 the cornering force of Sample 1 as for Table 2, and Sample 11 as for Table 3. The results were as shown in Table 1. Here, a larger index value shows a larger cornering power and more excellent steering stability.

(2) Wet Road Turning G Index

Each sample was mounted to a vehicle, and was run while varying the turning radius on a steady-state circular course under the conditions of speed: 60 km and water depth: 2 mm. At this time, the vehicle G when running at a maximum radius such that the vehicle does not leave the course was measured with an accelerometer installed at a vehicle barycenter position.

The results thereof were indexed using as 100 the vehicle G of Sample 1 as for Table 2, and Sample 11 as for Table 3. The results were as shown in Table 1. Here, a larger index value shows a higher limit grip force and more excellent steering stability on wet road surface.

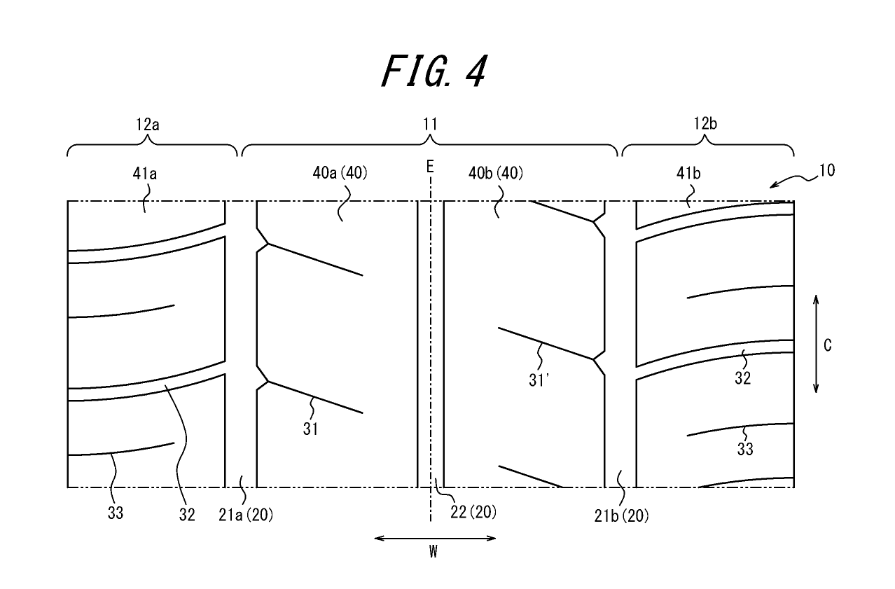

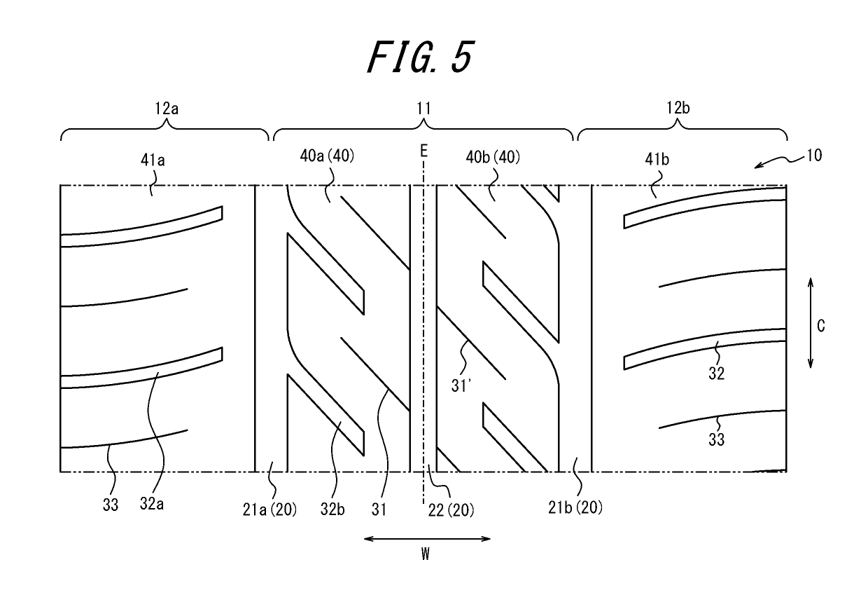

TABLE 2

| | | | Sample | | | | | |
|---|---|---|---|---|---|---|---|---|
| | | | 1 | 2 | 3 | 4 | 5 | 6 |
| | | | Comparative | Inventive | Inventive | Inventive | Inventive | Inventive |
| Conditions | | | example | example | example | example | example | example |
| Image of tread | | | FIG. 1 | FIG. 2 | FIG. 2 | FIG. 2 | FIG. 3 | FIG. 4 |
| Negative | Circumferential grooves | % | 11 | 11 | 11 | 11 | 11 | 11 |
| ratio on | Grooves other than | % | 19 | 11 | 9 | 9 | 9 | 9 |
| contact patch | circumferential grooves | | | | | | | |
| | Total negative ratio | % | 30 | 20 | 20 | 20 | 20 | 20 |
| | Comparison of side land portion | — | Larger central | Larger side | Larger side | Larger side | Larger side | Larger side |
| | row and central land portion row | | land portion | land portion | land portion | land portion | land portion | land portion |
| | | | row | row | row | row | row | row |
| Conditions of | Ratio of central land portion row | % | 45 | 45 | 45 | 50 | 50 | 50 |
| central land | Land portion width/adjacent main | — | 3.6 | 3.6 | 3.6 | 4.4 | 4.4 | 4.4 |
| portion row | groove depth | | | | | | | |
| | Preseuce/absence of lug grooves | — | Presence | Presence | Presence | Presence | Absence | Absence |
| | Area ratio of raised bottom region | % | 55 | 20 | 20 | 20 | 0 | 0 |
| | of lug groove | | | | | | | |
| | Type of narrow grooves | — | Sipe | Sipe | Sipe | Sipe | Sipe | Sipe |
| | Arranging spacing of narrow | % | 1.1 | 1.1 | 1.1 | 1.1 | 1.1 | 1.1 |
| | grooves/tread circumferential | | | | | | | |
| | length | | | | | | | |
| | Extension angle with respect to tire | ° | 40 | 40 | 40 | 40 | 70 | 70 |
| | circumferential direction of sipes | | | | | | | |
| Conditions of | Penetration of shoulder lugs | — | Absence | Absence | Absence | Absence | Presence | Presence |
| side land | to main groove | | | | | | | |
| portion row | Raised bottom of shoulder lugs | — | Absence | Absence | Absence | Absence | Presence | Presence |
| | Raised bottom region cross- | % | 0 | 0 | 0 | 0 | 25 | 25 |
| | sectional area/lug groove cross- | | | | | | | |
| | sectional area | | | | | | | |
| | Lug groove width | — | Constant | Constant | Constant | Constant | Constant | Smaller on |
| | | | | | | | | circumferential |
| | | | | | | | | groove side |
| Performance | Cornering power index | Index | 100 | 103 | 102 | 104 | 107 | 108 |
| evaluation | Wet road turning G index | Index | 100 | 100 | 100 | 100 | 101 | 103 |

| | | | Sample | | | |
|---|---|---|---|---|---|---|
| | | | 7 | 8 | 9 | 10 |
| | | | Comparative | Comparative | Inventive | Inventive |
| Conditions | | | example | example | example | example |
| Image of tread | | | FIG. 1 | FIG. 1 | FIG. 5 | FIG. 1 |
| Negative | Circumferential grooves | % | 7 | 17 | 11 | 11 |
| ratio on | Grooves other than | % | 6 | 13 | 9 | 9 |
| contact patch | circumferential grooves | | | | | |
| | Total negative ratio | % | 13 | 30 | 20 | 20 |
| | Comparison of side land portion | — | Larger side | Larger side | Larger side | Larger side |
| | row and central land portion row | | land portion | land portion | land portion | land portion |
| | | | row | row | row | row |
| Conditions of | Ratio of central land portion row | % | 45 | 45 | 55 | 50 |
| central land | Land portion width/adjacent main | — | 5.5 | 2.5 | 1.4 | 4.4 |
| portion row | groove depth | | | | | |
| | Preseuce/absence of lug grooves | — | Presence | Presence | Presence | Absence |
| | Area ratio of raised bottom region | % | 55 | 55 | 55 | 0 |
| | of lug groove | | | | | |
| | Type of narrow grooves | — | Sipe | Sipe | Sipe | Sipe |
| | Arranging spacing of narrow | % | 1.1 | 1.1 | 1.1 | 5 |
| | grooves/tread circumferential | | | | | |
| | length | | | | | |
| | Extension angle with respect to tire | ° | 40 | 40 | 40 | 70 |
| | circumferential direction of sipes | | | | | |
| Conditions of | Penetration of shoulder lugs | — | Absence | Absence | Absence | Presence |
| side land | to main groove | | | | | |
| portion row | Raised bottom of shoulder lugs | — | Absence | Absence | Absence | Presence |
| | Raised bottom region cross- | % | 0 | 0 | 0 | 25 |
| | sectional area/lug groove cross- | | | | | |
| | sectional area | | | | | |
| | Lug groove width | — | Constant | Constant | Constant | Smaller on |
| | | | | | | circumferential |
| | | | | | | groove side |
| Performance | Cornering power index | Index | 104 | 96 | 97 | 110 |
| evaluation | Wet road turning G index | Index | 97 | 105 | 100 | 98 |

TABLE 3

| | | | Sample | | | | | |
|---|---|---|---|---|---|---|---|---|
| | | | 11 | 12 | 13 | 14 | 15 | 16 |
| | | | Comparative | Inventive | Inventive | Inventive | Inventive | Inventive |
| Conditions | | | example | example | example | example | example | example |
| Image of tread | | | FIG. 1 | FIG. 2 | FIG. 2 | FIG. 2 | FIG. 3 | FIG. 4 |
| Negative ratio | Circumferential grooves | % | 11 | 11 | 11 | 11 | 11 | 11 |
| on contact | Grooves other than circumferential | % | 19 | 11 | 9 | 9 | 9 | 9 |
| patch | grooves | | | | | | | |
| | Total negative ratio | % | 30 | 20 | 20 | 20 | 20 | 20 |
| | Comparison of side land portion | — | Larger central | Larger side | Larger side | Larger side | Larger side | Larger side |
| | row and central land portion | | land portion | land portion | land portion | land portion | land portion | land portion |
| | row | | row | row | row | row | row | row |
| Conditions of | Ratio of central land portion row | % | 45 | 45 | 45 | 50 | 50 | 50 |
| central land | Land portion width/adjacent | — | 3.6 | 3.6 | 3.6 | 4.4 | 4.4 | 4.4 |
| portion row | main groove depth | | | | | | | |
| | Presence/absence of lug grooves | — | Presence | Presence | Presence | Presence | Absence | Absence |
| | Area ratio of raised bottom | % | 55 | 20 | 20 | 20 | 0 | 0 |
| | region of lug groove | | | | | | | |
| | Type of narrow groove | — | Sipe | Sipe | Sipe | Sipe | Sipe | Sipe |
| | Arranging spacing of narrow | % | 1.1 | 1.1 | 1.1 | 1.1 | 1.1 | 1.1 |
| | grooves/tread | | | | | | | |
| | circumferential length | | | | | | | |
| | Extension angle with respect | ° | 40 | 40 | 40 | 40 | 70 | 70 |
| | to tire circumferential | | | | | | | |
| | direction of sipes | | | | | | | |
| Conditions of | Penetration of shoulder lugs | — | Absence | Absence | Absence | Absence | Presence | Presence |
| side land | to main groove | | | | | | | |
| portion row | Raised bottom of shoulder lugs | — | Absence | Absence | Absence | Absence | Presence | Presence |
| | Raised bottom region | % | 0 | 0 | 0 | 0 | 25 | 25 |
| | cross-sectional area/ | | | | | | | |
| | lug groove cross- | | | | | | | |
| | sectional area | | | | | | | |
| | Lug groove width | — | Constant | Constant | Constant | Constant | Constant | Smaller on |
| | | | | | | | | circumferential |
| | | | | | | | | groove side |
| Performance | Cornering power index | Index | 100 | 102 | 103 | 105 | 106 | 108 |
| evaluation | Wet road turning G index | Index | 100 | 100 | 100 | 100 | 102 | 103 |

| | | | Sample | | | |
|---|---|---|---|---|---|---|
| | | | 17 | 18 | 19 | 20 |
| | | | Comparative | Comparative | Inventive | Inventive |
| Conditions | | | example | example | example | example |
| Image of tread | | | FIG. 1 | FIG. 1 | FIG. 5 | FIG. 1 |
| Negative ratio | Circumferential grooves | % | 7 | 17 | 11 | 11 |
| on contact | Grooves other than circumferential | % | 6 | 13 | 9 | 9 |
| patch | grooves | | | | | |
| | Total negative ratio | % | 13 | 30 | 20 | 20 |
| | Comparison of side land portion | — | Larger side | Larger side | Larger side | Larger side |
| | row and central land | | land portion | land portion | land portion | land portion |
| | portion row | | row | row | row | row |
| Conditions of | Ratio of central land portion row | % | 45 | 45 | 55 | 50 |
| central land | Land portion width/adjacent | — | 5.5 | 2.5 | 1.4 | 4.4 |
| portion row | main groove depth | | | | | |
| | Presence/absence of lug grooves | — | Presence | Presence | Presence | Absence |
| | Area ratio of raised bottom | % | 55 | 55 | 55 | 0 |
| | region of lug groove | | | | | |
| | Type of narrow groove | — | Sipe | Sipe | Sipe | Sipe |
| | Arranging spacing of narrow | % | 1.1 | 1.1 | 1.1 | 5 |
| | grooves/tread | | | | | |
| | circumferential length | | | | | |
| | Extension angle with respect | ° | 40 | 40 | 40 | 70 |
| | to tire circumferential | | | | | |
| | direction of sipes | | | | | |
| Conditions of | Penetration of shoulder lugs | — | Absence | Absence | Absence | Presence |
| side land | to main groove | | | | | |
| portion row | Raised bottom of shoulder lugs | — | Absence | Absence | Absence | Presence |
| | Raised bottom region | % | 0 | 0 | 0 | 25 |
| | cross-sectional area/ | | | | | |
| | lug groove cross- | | | | | |
| | sectional area | | | | | |
| | Lug groove width | — | Constant | Constant | Constant | Smaller on |
| | | | | | | circumferential |
| | | | | | | groove side |
| Performance | Cornering power index | Index | 104 | 95 | 97 | 110 |
| evaluation | Wet road turning G index | Index | 96 | 104 | 100 | 98 |

TABLE 4

| | |
|---|---|
| Formulation A | Formulation B |
| (parts by mass per 100 parts | (parts by mass per 100 parts |
| by mass of rubber component) | by mass of rubber component) |

| | | | |
|---|---|---|---|
| Natural rubber *1 | 100 | Natural rubber *1 | 85 |
| SBR1 *4 | 10 | Styrene-butadiene | 15 |
| | | rubber *3 | |
| Carbon black *2 | 8 | C9 based resin *6 | 15 |
| Silica *5 | 72 | Silica *5 | 72 |
| Silane coupling agent | 6 | Silane coupling agent | 6 |
| Aromatic oil | 10 | Carbon black *2 | 8 |
| Stearic acid | 2 | Stearic acid | 2 |
| Age resistor *9 | 1 | Zinc oxide | 2 |
| Zinc oxide | 2 | Age resistor | 1 |
| Vulcanization | 0.8 | Vulcanization | 0.8 |
| accelerator *10 | | accelerator *10 | |
| Sulfur | 1 | Sulfur | 1 |

*1: natural rubber RSS#3
*2: trade name: “#80”, made by Asahi Carbon Co., Ltd., N²SA 115 m²/g, N220 (ISAF)
*3: styrene-butadiene copolymer rubber #1500
*4: SB1 was produced under the following production conditions.
Charging a cyclohexane solution of butadiene (16%) and a cyclohexane solution of styrene (21%) in a dry, nitrogen-substituted pressure-resistant glass vessel (800 mL), such that butadiene monomer is 40 g and styrene monomer is 10 g; adding 0.66 mmol of 2,2-di(tetrahydrofuryl)propane, and adding 1.32 mmol of n-butyllithium (BuLi) thereto; then polymerizing in a warm bath at 50° C. for 1.5 hours. The polymerization conversion rate was approximately 100%. Then, further adding 0.5 ml of a 5 mass % isopropanol solution of 2,6-di-t-butylparacresol (BHT), to stop the reaction. Then, drying by a conventional method to obtain liquid SBR1.
As a result obtained by measuring the weight-average molecular weight (Mw) through gel permeation chromatography [GPC: HLC-8020, made by Tosoh Corporation, column: two of GMH-XL connected in series, made by Tosoh Corporation, detector: a differential refractometer (RI)], using monodisperse polystyrene as a reference, a polystyrene-equivalent weight-average molecular weight of the obtained liquid SBR1 was 80,000.
Moreover, as a result of determining the microstructure by infrared spectroscopy (Morello), and determining the bound styrene content from an integral ratio of 1H-NMR spectrum, the obtained liquid SBR1 had a bound styrene content of 25 mass % and a vinyl bond content of the butadiene moiety of 65 mass %.
*5: trade name “Nipsil AQ”, made by Tosoh Silica Corporation
*6: trade name “Nisseki Neopolymer ® 140”, made by JX Nippon Oil & Energy Corporation
*10: 6PPD

From the results in Tables 2 and 3, it was understood that each sample of the examples of this disclosure showed excellent results for cornering power index and wet road turning G index, and obtained excellent steering stability. On the other hand, it was understood that as compared to each sample of the examples of this disclosure, each sample of the comparative examples was worse in at least one of the cornering power index and the wet road turning G index, i.e., the steering stability.

### INDUSTRIAL APPLICABILITY

According to this disclosure, it is possible to provide a tire having excellent braking performance on dry road surface and on wet road surface, and having excellent steering stability.

### REFERENCE SIGNS LIST

10 tread

11 central region

12, 12a, 12b side region

20 circumferential groove

21, 21a, 21b circumferential groove

22, 22a, 22b circumferential groove

31, 31′ widthwise narrow groove

32, 32a, 32b lug groove

33 side region narrow groove

34, 34′ lug groove

E tire equator

C tire circumferential direction

W tire width direction

P arranging interval of widthwise narrow groove

X independent land portion width of central region

α extension angle with respect to tire circumferential direction of narrow width groove

S cross-section area in extension direction of lug groove

S1 cross-section area in lug groove extension direction in raised bottom region of lug groove

1. A tire comprising a tread formed by using a rubber composition of which a tan δ at 0° C. is 0.25 to 0.55, a difference between a tan δ at 30° C. and a tan δ at 60° C. is −0.02 to 0.07, and a dynamic storage modulus at a dynamic strain of 1% and 0° C. is 4 MPa to 20 MPa, wherein:
the tread has a circumferential groove extending continuously in a tire circumferential direction;
a negative ratio in a footprint is 15% to 25%;
a negative ratio derived from the circumferential groove is 8% to 14%; and
a negative ratio derived from grooves other than the circumferential groove is 7% to 11%.

2. The tire according to claim 1, wherein:
the tread has a central region partitioned by two circumferential grooves located on tire widthwise outermost sides among the circumferential grooves, and two side regions on tire widthwise outer sides of the central region; and
a negative ratio of the two side regions in the footprint is larger than a negative ratio of the central region in the footprint.

3. The tire according to claim 2, wherein:
a ratio of an area of a central land portion located within the central region to an area of an entire tire land portion on the footprint of the tread is from 40% to 60%, an independent land portion width of the central land portion being 1.5 times or more of a groove depth of the circumferential groove adjacent on a tire widthwise outer side of the central land portion.

4. The tire according to claim 3, wherein:
the central land portion has a plurality of widthwise narrow grooves which open to one of the circumferential grooves and do not connect to another adjacent circumferential groove.

5. The tire according to claim 4, wherein:
the widthwise narrow grooves extend in a direction at 50° to 85° with respect to the tire circumferential direction.

6. The tire according to claim 4, wherein:
the widthwise narrow grooves are arranged alternately in the tire circumferential direction with widthwise narrow grooves extending oppositely across a tire equator, an arranging interval in the tire circumferential direction of widthwise narrow grooves opening to the same circumferential groove being 0.5% to 4.5% of a circumferential length of a tire equatorial plane on a tread surface.

7. The tire according to claim 4, wherein:
the widthwise narrow grooves are comprised of sipes and/or notch grooves.

8. The tire according to claim 1, wherein:
side land portions located within the side regions have lug grooves, each of the lug grooves not connecting to an adjacent one of the circumferential grooves, or connecting to the adjacent one of the circumferential grooves in a state where a part of a groove bottom is raised up.

9. The tire according to claim 1, wherein:
the tread is formed with a rubber composition containing: a rubber component A containing 50 mass % or more of a diene based rubber; and 5 to 50 parts by mass per 100 parts by mass of the rubber component of at least one additive component B selected from a thermoplastic resin, an oil or a low molecular weight aromatic vinyl compound-conjugated diene compound copolymer with a polystyrene-equivalent weight-average molecular weight of 5,000 to 200,000 measured by gel permeation chromatography.

10. The tire according to claim 9, wherein:
the diene based rubber is a natural rubber or a butadiene rubber.

11. The tire according to claim 9, wherein:
the thermoplastic resin is a C5 based resin, a C9 based resin, a C5 to C9 based resin, a dicyclopentadiene based resin, a rosin based resin, an alkylphenol based resin, or a terpenephenol based resin.

12. The tire according to claim 9, wherein:
the additive component B contains a Novolak-type phenol resin.

13. The tire according to claim 9, wherein:
the rubber composition further contains a carbon black with a nitrogen adsorption specific surface area of 110 m²/g or more and a carbon black with a nitrogen adsorption specific surface area of 80 m²/g or less.

14. The tire according to claim 1, wherein:
the rubber composition contains 50 mass % or more of a styrene-butadiene rubber of which the percentage of a bound styrene content among all polymer units+the percentage of a vinyl bond content among all polymer units×½ equals 25% or less.

15. The tire according to claim 2, wherein:
side land portions located within the side regions have lug grooves, each of the lug grooves not connecting to an adjacent one of the circumferential grooves, or connecting to the adjacent one of the circumferential grooves in a state where a part of a groove bottom is raised up.

16. The tire according to claim 2, wherein:
the tread is formed with a rubber composition containing: a rubber component A containing 50 mass % or more of a diene based rubber; and 5 to 50 parts by mass per 100 parts by mass of the rubber component of at least one additive component B selected from a thermoplastic resin, an oil or a low molecular weight aromatic vinyl compound-conjugated diene compound copolymer with a polystyrene-equivalent weight-average molecular weight of 5,000 to 200,000 measured by gel permeation chromatography.

17. The tire according to claim 2, wherein:
the rubber composition contains 50 mass % or more of a styrene-butadiene rubber of which the percentage of a bound styrene content among all polymer units+the percentage of a vinyl bond content among all polymer units×½ equals 25% or less.

18. The tire according to claim 3, wherein:
side land portions located within the side regions have lug grooves, each of the lug grooves not connecting to an adjacent one of the circumferential grooves, or connecting to the adjacent one of the circumferential grooves in a state where a part of a groove bottom is raised up.

19. The tire according to claim 3, wherein:
the tread is formed with a rubber composition containing: a rubber component A containing 50 mass % or more of a diene based rubber; and 5 to 50 parts by mass per 100 parts by mass of the rubber component of at least one additive component B selected from a thermoplastic resin, an oil or a low molecular weight aromatic vinyl compound-conjugated diene compound copolymer with a polystyrene-equivalent weight-average molecular weight of 5,000 to 200,000 measured by gel permeation chromatography.

20. The tire according to claim 3, wherein:
the rubber composition contains 50 mass % or more of a styrene-butadiene rubber of which the percentage of a bound styrene content among all polymer units+the percentage of a vinyl bond content among all polymer units×½ equals 25% or less.
